(19) United States
(12) Patent Application Publication
(10) Pub. No.: US 2007/0262698 A1
(43) Pub. Date: Nov. 15, 2007

(54) LIGHT EMITTING DEVICE AND ASSOCIATED METHODS OF MANUFACTURE

(75) Inventor: Stalimir Popovich, North Redington Beach, FL (US)

Correspondence Address: LATHROP & GAGE LC, 4845 PEARL EAST CIRCLE, SUITE 300, BOULDER, CO, 80301, US

(73) Assignee: TELEGEN CORPORATION, San Mateo, CA (US)

(21) Appl. No.: 11/684,303

(22) Filed: Mar. 9, 2007

Related U.S. Application Data
(63) Continuation-in-part of application No. PCT/US05/45713, filed on Dec. 16, 2005.
(60) Provisional application No. 60/780,930, filed on Mar. 9, 2006.

(51) Int. Cl. H01J 63/04

(52) U.S. Cl. 313/497

(57) ABSTRACT

A light emitting device includes an enclosure with a face portion, a cold cathode within the enclosure, a phosphor layer disposed on an interior surface of the face portion, and a tubulator between the cold cathode and the phosphor layer, the tubulator having a conductive insert. Electrons from the cold cathode are defocused by the conductive insert and impact the phosphor layer when an electric field is created between the cold cathode and the phosphor layer due to applied voltages at the cold cathode, conductive insert and phosphor layer. The phosphor layer emits light through the face portion in response to electrons incident thereon.

### CROSS REFERENCE TO RELATED APPLICATIONS

This application is a continuation-in-part of commonly-owned and copending Patent Cooperative Treaty Application No. PCT/US2005/045713, filed 16 Dec. 2005 and incorporated herein by reference. This application also claims priority to commonly-owned U.S. Provisional Patent Application No. 60/780,930, filed 9 Mar. 2006 and incorporated herein by reference.

### BACKGROUND

Lights for displays such as advertising, signage, signals or emergency signaling are typically of three types: incandescent, fluorescent and light emitting diodes (LED). Each of these types of lights has drawbacks that make them undesirable in certain applications. For example, although incandescent lights are readily available in various colors, and are able to emit bright light viewable from substantially any angle, incandescent lights also produce a substantial amount of heat in comparison to quantity of light emitted. Thus, the heat generation of incandescent lights wastes electrical power. Fluorescent lights also produce substantial amounts of heat, but brightness and shapes of fluorescent lights are limited.

Alternatively, LEDs produce a relatively low amount of heat in comparison to the light emitted, and thus use substantially less electrical power as compared to incandescent lights. However, there are numerous restrictions on LEDs. For example, LEDs are typically circular or cylindrical; and it is not cost-effective for LEDs to be manufactured in an alternative shape that is better suited to a particular lighting application. Additionally, white light or multiple-color LEDs are not yet cost-effectively manufactured. LEDs also have relatively slow blink rates (e.g., 5 kHz) which causes a video display of sixty-four or higher levels of brightness to be distorted, for example, making it difficult or impossible to create animated displays with arrays of LEDs. Further, LEDs have a relatively narrow emission angle within which emitted light is effectively viewed—typically a maximum of 120 to 130 degrees.

### SUMMARY

In one embodiment, a light emitting device includes an enclosure with a face portion, a cold cathode within the enclosure, a phosphor layer disposed on an interior surface of the face portion, a tubulator between the cold cathode and the phosphor layer, the tubulator having a conductive insert, a first electrical conductor extending through the enclosure to provide electrical connectivity to the cold cathode, a second electrical conductor extending through the enclosure to provide electrical connectivity to the conductive insert and a third electrical conductor extending through the enclosure to provide electrical connectivity to the phosphor layer. Electrons from the cold cathode are defocused by the conductive insert and impact the phosphor layer when an electric field is created between the cold cathode and the phosphor layer due to applied voltages at the cold cathode, conductive insert and phosphor layer. The phosphor layer emits light through the face portion in response to electrons incident thereon.

In another embodiment, a light emitting device includes an enclosure with a face portion, a cold cathode within the enclosure, a phosphor layer disposed on an interior surface of the face portion, a conductive ring between the cold cathode and the phosphor layer, a first electrical conductor extending through the enclosure to provide electrical connectivity to the cold cathode, a second electrical conductor extending through the enclosure to provide electrical connectivity to the conductive ring, and a third electrical conductor extending through the enclosure to provide electrical connectivity to the phosphor layer. Electrons from the cold cathode impact the phosphor layer when an electric field is created between the cold cathode and the phosphor layer due to applied voltages at the cold cathode, conductive ring and phosphor layer. The phosphor layer emits light through the face portion in response to electrons incident thereon.

In another embodiment, a light emitting device includes an enclosure with a face portion, a transparent conductive coating on the interior surface of the face portion, a phosphor layer disposed on an interior surface of the enclosure opposite to the face portion, a cold cathode within the enclosure, a conductive ring between the cold cathode and the face portion, a first electrical conductor extending through the enclosure to provide electrical connectivity to the cold cathode, a second electrical conductor extending through the enclosure to provide electrical connectivity to the conductive ring, a third electrical conductor extending through the enclosure to provide electrical connectivity to the transparent conductive coating, and a fourth electrical conductor extending through the enclosure to provide electrical connectivity to the phosphor layer. Electrons from the cold cathode are defocused by the conductive ring and impact the phosphor layer when an electric field is created between the cold cathode and the phosphor layer due to applied voltages at the cold cathode, conductive insert, transparent conductive coating and phosphor layer. The phosphor layer emits light through the transparent conductive coating and face portion in response to electrons incident thereon.

### BRIEF DESCRIPTION OF THE FIGURES

FIG. 1 shows one light emitting device constructed with three conductors, a cathode and a tubulator with a conductive insert, in accord with an embodiment.

FIG. 2 shows exemplary electron beam defocusing resulting from the tubulator with the conductive insert of FIG. 1.

FIG. 3 shows one exemplary tubulator with an extension that generates secondary electron emissions.

FIG. 4 shows one light emitting device constructed with three conductors, a cathode, a conductive ring and a separator, in accord with an embodiment.

FIG. 5 shows one light emitting device with a lens, in accord with one embodiment.

FIG. 6 shows one light emitting device with a lens and mirrored surfaces, in accord with one embodiment.

FIG. 7 shows one light emitting device with an electron reflective surface, in accord with one embodiment.

FIG. 8 shows the embodiment of FIG. 7 with mirrored surfaces and shaped phosphor surfaces.

FIG. 9 shows a light emitting device, similar to the embodiment of FIG. 7, with an additional mirrored surface and shaped surfaces.

FIG. 10 shows one exemplary device controller for powering the light emitting device of FIG. 1, in accord with one embodiment.

FIG. 11 shows an alternate embodiment of the tubulator of FIG. 3.

FIGS. 12 and 13 show alternate embodiments of the light emitting device illustrating exemplary use of shaped surfaces.

### DETAILED DESCRIPTION OF THE FIGURES

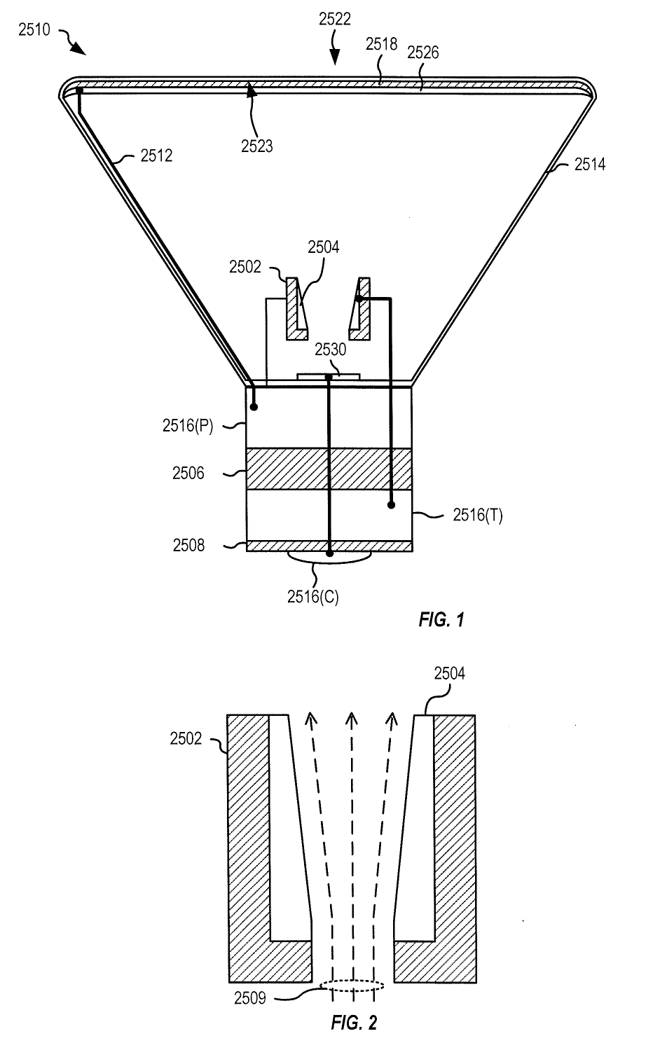

FIG. 1 shows one exemplary light emitting device 2510 constructed with three conductors 2516(P), 2516(T) and 2516(C), a cathode 2530 and a tubulator 2502; tubulator 2502 has a conductive insert 2504. FIG. 2 shows exemplary electron beam defocusing resulting from tubulator 2502 and conductive insert 2504. FIGS. 1 and 2 are best views together with the following description.

Light emitting device 2510 has an enclosure 2514 with a face portion 2522. The interior surface 2523 of face portion 2522 is coated with a phosphor 2518 and a mirror layer 2526. A base section 2504 provides three electrical connection points 2516(P), 2516(T) and 2516(C) that connect phosphor 2518 (via mirror layer 2526) to conductive insert 2504 and to cathode 2530, respectively. An insulator 2506 electrically insulates connection points 2516(P) and 2516(T) from each other; and an insulator 2508 electrically insulates connection points 2516(T) and 2516(C) from each other. In the embodiment of FIG. 1, connection point 2516(P) connects to phosphor 2518 (and mirror layer 2526) via connector 2512, which is for example insulated to prevent electron interaction.

In an example of operation, connection point 2516(T) is connected to ground (zero volts), connection point 2516(C) is connected to a negative voltage supply (e.g., −250V) and connection point 2516(P) is connected to a positive voltage supply (e.g., +10,000V). The electric field produced between cathode 2530 and conductive insert 2504 accelerates electrons from cathode 2530, through tubulator 2502, towards phosphor 2518. The shape, length and electrical potential of conductive insert 2504 defocuses electron beam 2509, emitted by cathode 2530, to produce a uniform electron distribution over phosphor 2518, and hence a uniform light distribution across face portion 2522. The voltage differential between cathode 2530 and conductive insert 2504 may be varied (e.g., by varying the voltage applied to connection point 2516(C) and/or connection point 2516(T)) to modify the light intensity output from light emitting device 2510.

In an alternate embodiment, tubulator 2502 is conductive and is shaped to include conductive insert 2404, which is then omitted. Thus, in this alternate embodiment, tubulator 2502 operates to extract and accelerate electrons from cathode 2530 towards phosphor 2518, defocus and multiply these electrons such that a uniform light distribution from face portion 2522 is achieved.

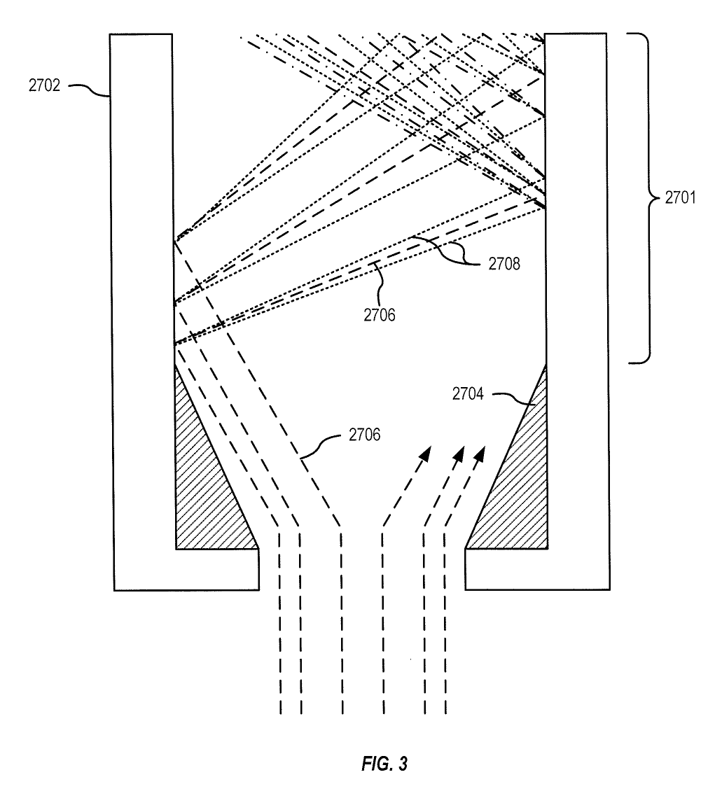

FIG. 3 shows one exemplary tubulator 2702 with an extension 2701 that generates secondary electron emissions 2708 from primary electron emission 2706. Tubulator 2702 may have a plating to enhance secondary emissions. A light emitting device (e.g., light emitting device 2610) may include multiple tubulators 2702 (and conductive inserts 2704) to create a uniform light distribution emitted therefrom.

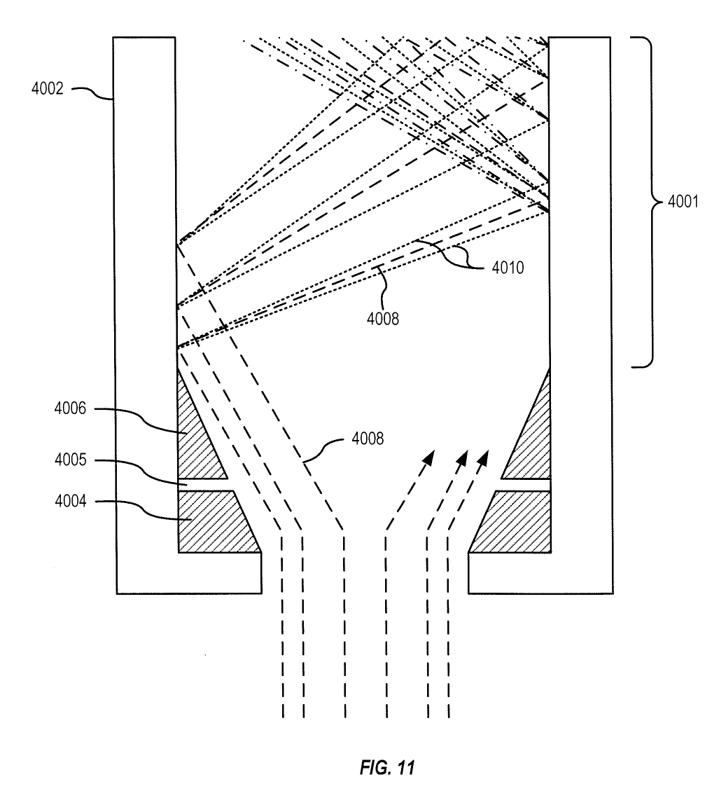

FIG. 11 shows a tubulator 4002 embodiment illustrating an extension 4001 and two conductive inserts 4004 and 4006. Extension 4001 generates secondary electron emissions 4010 from primary electron emissions 4008. Tubulator 4002 may have a plating to enhance secondary emissions. Conductive inserts 4004 and 4006 are electrically insulated from each other (e.g., by gap 4005) and may have different voltage potentials to allow additional control of electron extraction and defocusing. The shape, length and diameter of conductive inserts 4004 and 4006 may also be modified to control electron extraction and defocusing. A light emitting device (e.g., light emitting device 2610) may include multiple tubulators 4002 (and conductive inserts 4004, 4006) to create a uniform light distribution emitted therefrom.

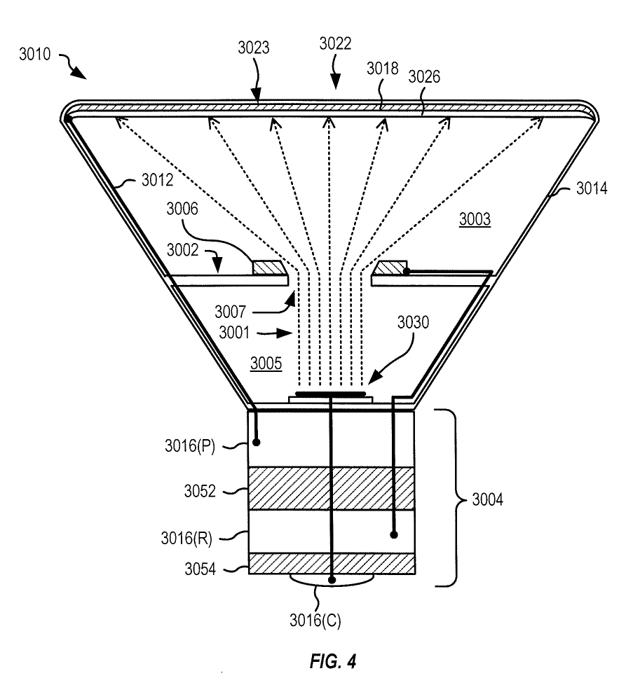

FIG. 4 shows one exemplary light emitting device 3010 constructed with three conductors 3016(P), 3016(R) and 3016(C), a cathode 3030, a conductive ring 3006 and a separator 3002. Light emitting device 3010 has an enclosure 3014 with a face portion 3022. An interior surface 3023 of face portion 3022 is first coated with a phosphor 3018 and then a mirror layer 3026. Separator 3002 separates an upper cavity 3003, which during operation has a high electric field, from a lower cavity 3005, which during operation has a low electric field. Separator 3002 forms a hole 3007 between phosphor 3018 and cathode 3030 such that the high electric field produced by phosphor 3018 (and/or mirror layer 3026) during operation protrudes through the hole towards cathode 3030. A conductive ring 3006 is attached to separator 3002 and mounted over hole 3007. Cathode 3030 is illustratively shown with a substrate and an electron emitting material. The high electric field extracts electrons from cathode 3030. The diameter of hole 3007 and conductive ring 3006, field strength and distance of the hole from cathode 3030 determine the electron extraction.

Separator 3002 may be made of glass and formed together with enclosure 3014. Alternatively, separator 3002 may be a non-conductive material positioned and fixed within enclosure 3014. A base section 3004 of device 3010 provides three electrical connection points 3016(P), 3016(R) and 3016(C) that connect phosphor 3018 (via mirror layer 3026) to conductive ring 3006 and to cathode 3030, respectively. An insulator 3052 electrically insulates connection points 3016(P) and 3016(R) from each other; and an insulator 3054 electrically insulates connection points 3016(R) and 3016(C) from each other. In the embodiment of FIG. 4, connection point 3016(P) connects to phosphor 3018 (and mirror layer 3026) via connector 3012, which is for example insulated to prevent electron interaction. Separator 3002 also reduces ion bombardment of cathode 3030.

In an example of operation, connection point 3016(R) is connected to ground (zero volts), connection point 3016(C) is connected to a negative voltage supply (e.g., −250V) and connection point 3016(P) is connected to a positive voltage supply (e.g., +10,000V). A strong electric field is generated between cathode 3030 and conductive ring 3006; it extends through hole 3007 in separator 3002 towards cathode 3030, causing electrons (shown as electron beam 3001) to be extracted from cathode 3030 and accelerated through hole 3007 towards phosphor 3018. The shape of conductive ring 3006 and the electric field created by conductive ring 3006 defocuses electron beam 3001 to produce a uniform electron distribution over phosphor 3018, and hence a uniform light distribution across face portion 3022.

In another example of operation, connection point 3016(R) is connected to a positive voltage supply (e.g., +500V), connection point 3016(C) is connected to ground (zero volts) and connection point 3016(P) is connected to a positive voltage supply (e.g., +10,000V).

The intensity of light produced by light emitting device 3010 may be adjusted by either varying the voltage applied to connection point 3016(P), and hence phosphor 3018, and/or by varying the voltage applied to connection point 3016(R), and hence conductive ring 3006.

In another embodiment, conductive ring 3006 is replaced by two conductive rings, an extraction ring and a defocusing ring. The voltage applied to each conductive ring may be varied to improve emission of light from device 3010. Further, the defocusing ring may be replaced by a defocusing grid with similar operation.

In an alternate embodiment, conductive ring 3006 may be replaced by a defocusing grid such that electron beam 3001 is distributed uniformly over phosphor 3018.

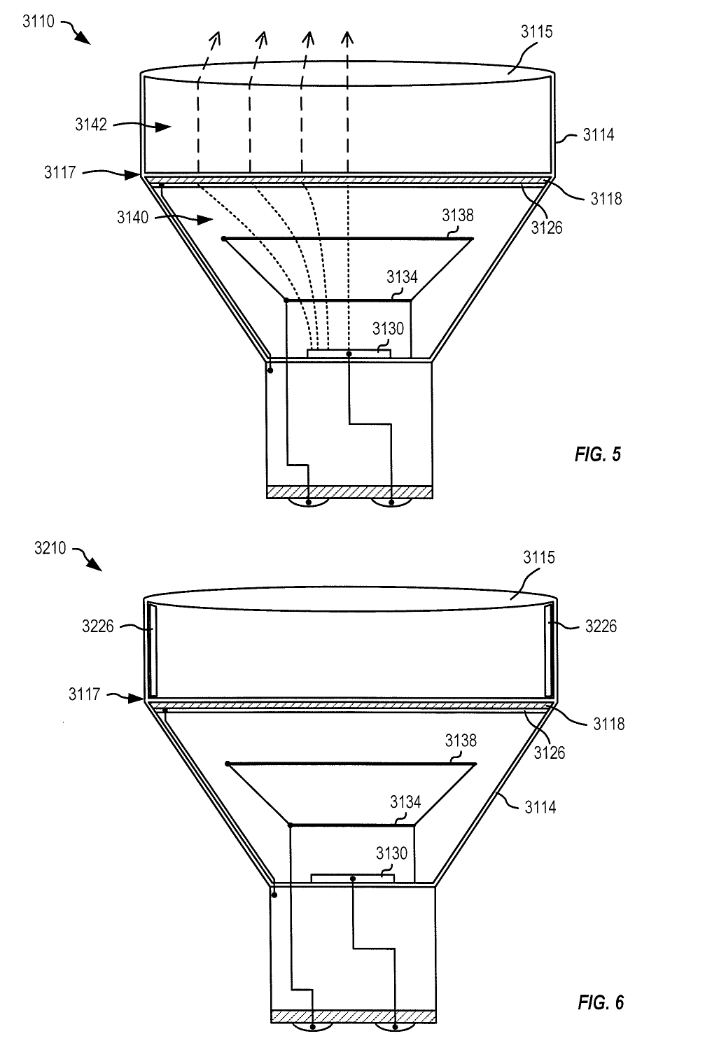

FIG. 5 shows one embodiment of a light emitting device 3110 with a lens 3115. Light emitting device 3110 has an enclosure 3114 that contains a cold cathode 3130, an extracting grid 3134, a defocusing grid 3138 and a glass screen 3117, onto which is deposited a phosphor 3118 and a mirror layer 3126.

In an example of operation, an electric field generated by a potential difference between cold cathode 3130 and extraction grid 3134 extracts electrons (indicated by exemplary electron paths 3140) from cold cathode 3130 and accelerates these electrons towards phosphor 3118. Defocusing grid 3138 changes the trajectory of these electrons to form an even distribution over phosphor 3118. Phosphor 3118, when impacted by the electrons, generates light as shown by light rays 3142. As light rays 3142 pass through lens 3115, they are focused (or defocused), as shown. Specifically, lens 3115 may be selected to focus or defocus light emitted by light emitting device 3110 as desired.

Glass screen 3117 may have a shaped surface to provide a desired light distribution to lens 3115. For example, glass screen 3117, phosphor 3118 and mirror layer 3126 may be formed with a convex or a concave surface.

FIG. 6 shows one exemplary embodiment of a light emitting device 3210 with a lens 3115 and a mirror layer 3226. Light emitting device 3210 is similar to light emitting device 3110, FIG. 5, with the addition of a mirror layer 3226 that provides additional light focusing and reduces light dispersion through the side of the enclosure 3114.

Lens 3115 may also be added to other embodiments of light emitting device described herein. For example, lens 3115, and optionally mirror layer 3226, may be added to light emitting devices 3010, 3310 and 3410 of FIGS. 4, 7 and 9, respectively, without departing from the scope hereof.

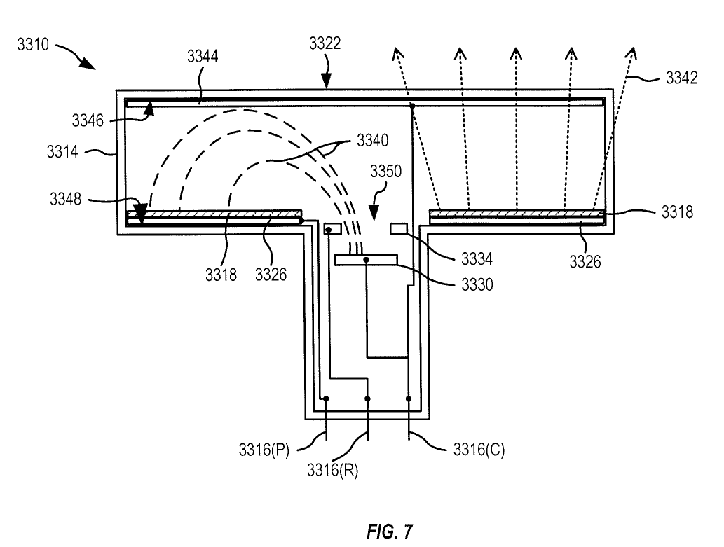

FIG. 7 shows one exemplary embodiment of a light emitting device with an electron reflective surface 3346; surface 3346 is an inside surface of a face portion 3322 of enclosure 3314 and is coated with a conductive transparent layer 3344 of indium tin oxide (ITO). Other transparent conductive layers may be used in place of ITO. A second surface 3348 parallel and opposite to surface 3346 is coated with a mirror layer 3326 and a phosphor 3318. A central recess 3350 within surface 3348 contains a cold cathode 3330 and a conductive ring 3334. Conductive ring 3334 is electrically connected to pin 3316(R), cold cathode 3330 is electrically connected to pin 3316(C), and mirror layer 3326 (and therefore phosphor 3318) is electrically connected to pin 3316(P).

In an example of operation, a voltage differential is applied between cold cathode 3330 and conductive ring 3334 (via pins 3316(C) and 3316(R), respectively) such that electrons are extracted from cold cathode 3330 and accelerated, as a beam of electrons, towards surface 3346. Conductive ring 3334 is shaped such that the beam of electrons is also defocused. Transparent layer 3344 may be held at a negative or neutral potential and therefore acts as an electron mirror, repelling the electrons. A positive potential (e.g., 10 kV) is applied via pin 3316(P) to mirror layer 3326 (and phosphor 3318) thereby attracting electrons to phosphor 3318, as shown by exemplary electron paths 3314. Light, emitted from phosphor 3318 when excited by the electrons, passes through transparent layer 3344 and face portion 3322, as shown by arrows 3342.

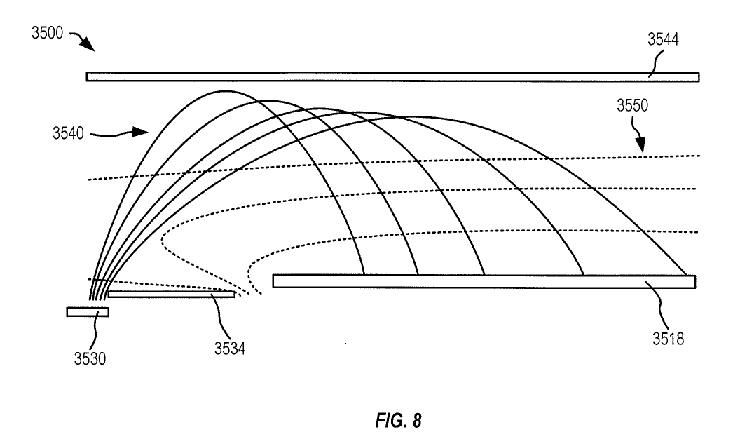

FIG. 8 shows exemplary output 3500 from a computer simulation of light emitting device 3310, FIG. 7. In particular, output 3500 represents half of light emitting device 3310 and shows a cold cathode 3530, a conductive ring 3534, a transparent layer 3544 and phosphor 3518. In this simulation, a distance of 3.5 cm exists between cold cathode 3530 and transparent layer 3544. Cold cathode 3530 is separated from conductive ring 3534 by a distance of 500 microns. Cold cathode 3530 and transparent layer 3544 are at a potential of zero volts (i.e., ground), conductive ring 3534 is at a potential of 3.2 kV, and phosphor 3518 is at a potential of 9 kV. Electric field contours 3550 illustrate the determined distribution of the electric field between cold cathode 3530, conductive ring 3534, transparent layer 3544 and phosphor 3518 during the simulation. Electron initial lateral energy is assumed to be 25 eV. The resulting electron spread indicated by electron paths 3540 show that a device with a diameter of 100 mm is reasonable using the configuration of FIG. 7.

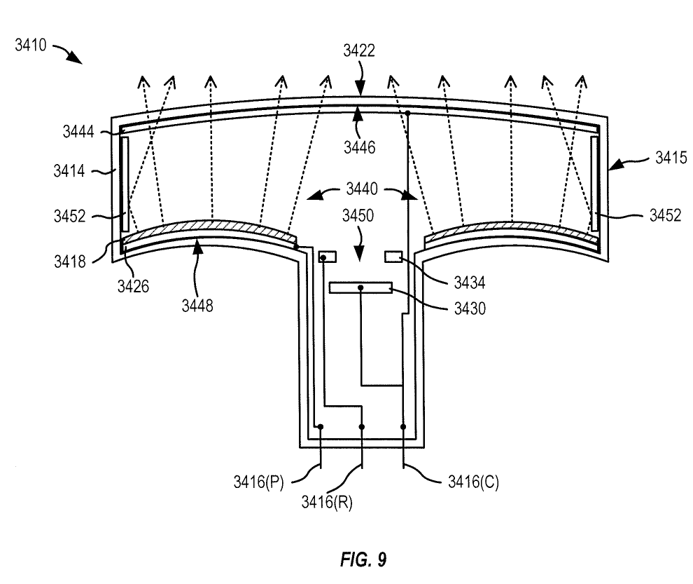

FIG. 9 shows a light emitting device 3410 that is similar to the light emitting device 3310, FIG. 7, with an additional mirrored surface 3426 and other shaped surfaces. Additional mirror layer 3452 minimizes light dispersion through sides 3415 of light emitting device 3410, for example. An inside surface 3446 of a face portion 3422 is coated with a conductive transparent layer 3444 of ITO. Face portion 3422 (and inside surface 3446) may, for example, be shaped to enhance manufacturability and/or performance of light emitting device 3410. A second surface 3448, opposite to surface 3446, is coated with a mirror layer 3426 and a phosphor 3418. Second surface 3448 may also be shaped to enhance manufacturability and/or performance of light emitting device 3410. A central recess 3450 within surface 3448 contains a cold cathode 3430 and a conductive ring 3434. Conductive ring 3434 is electrically connected to pin 3416(R), cold cathode 3430 is electrically connected to pin 3416(C) and mirror layer 3426 (and therefore phosphor 3418) is electrically connected to pin 3416(P).

Operation of device 3410 is similar to operation of device 3310 with performance enhanced by shaped surfaces 3422, 3446 and/or 3448.

Techniques for producing cathode 30 are disclosed in the following patents and patent applications, each of which is fully incorporated herein by reference:
U.S. Pat. No. 5,646,474 entitled “Boron Nitride Cold Cathode”, filed Mar. 27, 1995; and
U.S. Pat. No. 6,388,366 entitled “Carbon Nitride Cold Cathode”, filed May 8, 1995.
WO9944215A1 entitled “FIELD EMITTER AND METHOD FOR PRODUCING THE SAME”, filed Feb. 27, 1998;
WO0040508A1 entitled “NANOSTRUCTURED FILM-TYPE CARBON MATERIAL AND METHOD FOR PRODUCING THE SAME”, filed Dec. 30, 1998; and
WO03088308A1 entitled “CATHODOLUMINESCENT LIGHT SOURCE”, filed Apr. 17, 2002.

Although carbon nano-tubes may work as an electron emitting material of cold cathode 2530, 3030, 3130, 3330, 3430, their structure is fragile and may break down under strong electrical fields, causing electrical shorting within, and thus failure of, the light emitting device. Carbon nano-tubes may nonetheless be encapsulated within a conductive polymer material to reduce failure of the nano-tubes under strong electrical fields.

But the electron-emitting material may be formed of carbon crystal (e.g., diamond) that is deposited onto a substrate by CVD. Strict control of the CVD process may be used to prevent formation of nano-tubes and/or hair-like formations upon the substrate, since these nano-tubes and/or hair-like formations may cause shorting between the electron-emitting material of the cold cathode and tubulator 2502 and/or conductive insert 2504.

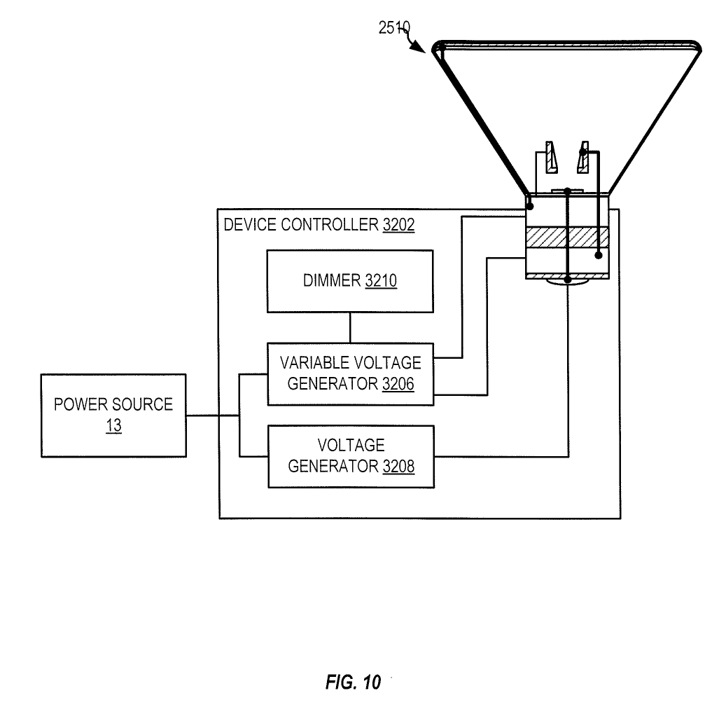

FIG. 10 shows one exemplary device controller 3202 for powering light emitting device 2510, FIG. 1. An external power source 13 (e.g., a battery or household electricity outlet) provides power to device controller 3202. Controller 3202 has a variable voltage generator 3206 that is controlled by a dimmer 3210 to adjust voltage potential difference between the cathode and extraction grid of light emitting device 2510. A voltage generator 3208 receives power from power source 3204 and produces a voltage for the mirror layer (e.g., mirror layer 1926, FIG. 10) and/or the phosphor (e.g., phosphor 1918) of light emitting device 2510. Dimmer 3210 may, for example, be a digitally controller device. In one embodiment, device controller 3202 may be incorporated within the base area (e.g., base area 1904). In another embodiment, multiple light emitting devices may be incorporated into one fixture such that power supplies and dimming functions are shared, thereby providing cost savings for the fixture as compared to individual light emitting devices.

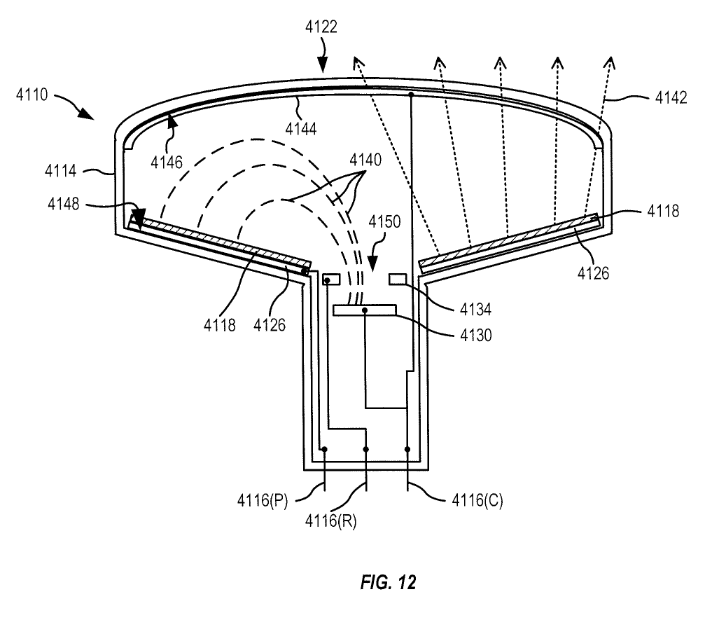

FIG. 12 shows one exemplary embodiment of a light emitting device 4110 with an electron reflective surface 4146; surface 4146 is an inside surface of a convex face portion 4122 of enclosure 4114 and is coated with a conductive transparent layer 4144 of indium tin oxide (ITO). Other transparent conductive layers may be used in place of ITO. A second conical surface 4148 facing surface 4146 is coated with a mirror layer 4126 and a phosphor 4118. A central recess 4150 within surface 4148 contains a cold cathode 4130 and a conductive ring 4134. Conductive ring 4134 is electrically connected to pin 4116(R), cold cathode 4130 is electrically connected to pin 4116(C), and mirror layer 4126 (and therefore phosphor 4118) is electrically connected to pin 4116(P).

In an example of operation, a voltage differential is applied between cold cathode 4130 and conductive ring 4134 (via pins 4116(C) and 4116(R), respectively) such that electrons are extracted from cold cathode 4130 and accelerated, as a beam of electrons, towards surface 4146. Conductive ring 4134 is shaped such that the beam of electrons is also defocused. Transparent layer 4144 may be held at a negative or neutral potential and therefore acts as an electron mirror, repelling the electrons. A positive potential (e.g., 10 kV) is applied via pin 4116(P) to mirror layer 4126 (and phosphor 4118) thereby attracting electrons to phosphor 4118, as shown by exemplary electron paths 4114. Light, emitted from phosphor 4118 when excited by the electrons, passes through transparent layer 4144 and face portion 4122, as shown by arrows 4142.

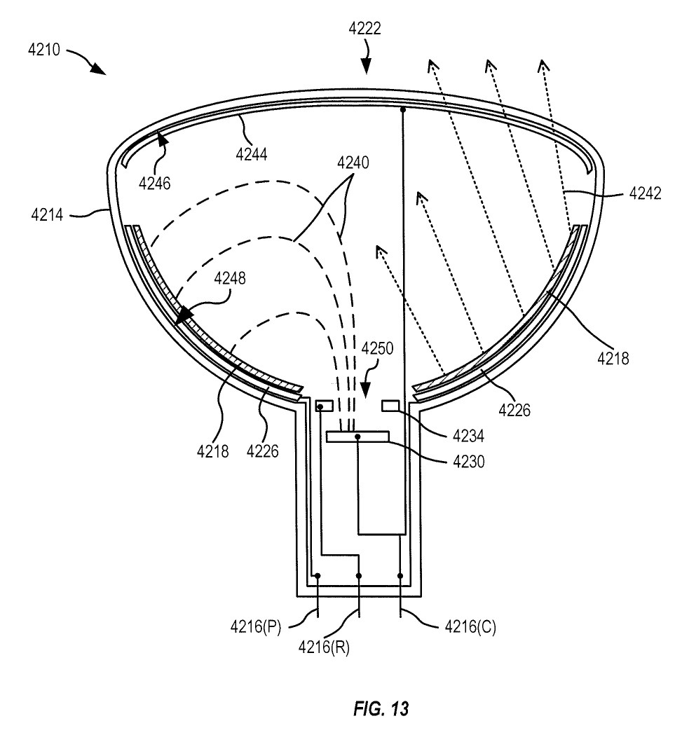

FIG. 13 shows one exemplary embodiment of a light emitting device 4210 with an electron reflective surface 4246; surface 4246 is an inside surface of a convex face portion 4222 of enclosure 4214 and is coated with a conductive transparent layer 4244 of indium tin oxide (ITO). Other transparent conductive layers may be used in place of ITO. A second curved surface 4248 facing surface 4246 is coated with a mirror layer 4226 and a phosphor 4218. A central recess 4250 within surface 4248 contains a cold cathode 4230 and a conductive ring 4234. Conductive ring 4234 is electrically connected to pin 4216(R), cold cathode 4230 is electrically connected to pin 4216(C), and mirror layer 4226 (and therefore phosphor 4218) is electrically connected to pin 4216(P).

In an example of operation, a voltage differential is applied between cold cathode 4230 and conductive ring 4234 (via pins 4216(C) and 4216(R), respectively) such that electrons are extracted from cold cathode 4230 and accelerated, as a beam of electrons, towards surface 4246. Conductive ring 4234 is shaped such that the beam of electrons is also defocused. Transparent layer 4244 may be held at a negative or neutral potential and therefore acts as an electron mirror, repelling the electrons. A positive potential (e.g., 10 kV) is applied via pin 4216(P) to mirror layer 4226 (and phosphor 4218) thereby attracting electrons to phosphor 4218, as shown by exemplary electron paths 4214. Light, emitted from phosphor 4218 when excited by the electrons, passes through transparent layer 4244 and face portion 4222, as shown by arrows 4242.

Each light emitting device 2510, 3010, 3110, 3210, 3310, 3410, 4110 and 4210 may also include an ion trapping system to prevent cold cathode damage. The ion removing system removes existing (e.g., ion already existing within the enclosure) and new (e.g., ions created by the electron emission process of the cold cathode) ions from within the enclosure (particularly proximate to the cold cathode). If these ions are not removed, they are attracted towards the cold cathode (since they are positively charged) and may cause damage to the cold cathode and reduce electron emission. By utilizing a positively charged ring or plated area around the cold cathode, ions are attracted to, and impact, this ring instead of the cold cathode, thus avoiding damage to the cold cathode.

The foregoing discussion has been presented for purposes of illustration and description. Further, the description is not intended to be limited to the form disclosed herein. Consequently, variations and modifications commensurate with the above teachings, within the skill and knowledge of the relevant art, are within the scope of the features disclosed herein. The embodiments described hereinabove are further intended to explain the best mode presently known of practicing the light emitting device and to enable others skilled in the art to utilize the features disclosed herein as such, or in other embodiments, and with the various modifications required by their particular application or use. It is intended that the appended claims be construed to include alternative embodiments to the extent permitted by the prior art.

Changes may be made in the above methods and systems without departing from the scope hereof. For example, cold cathodes 2530, 3030, 3130, 3330, 3430, 3530, 4130 and 4230 may be replaced by thermionic (hot) cathodes, requiring an additional conductor to power a heating element and resulting in the light emitting device operating at a slightly higher temperature and higher energy. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall there between.

What is claimed is:

1. Light emitting device, comprising:
an enclosure with a face portion;
a cold cathode within the enclosure;
a phosphor layer disposed on an interior surface of the face portion;
a tubulator between the cold cathode and the phosphor layer, the tubulator having a conductive insert;
a first electrical conductor extending through the enclosure to provide electrical connectivity to the cold cathode;
a second electrical conductor extending through the enclosure to provide electrical connectivity to the conductive insert; and
a third electrical conductor extending through the enclosure to provide electrical connectivity to the phosphor layer;
electrons from the cold cathode being defocused by the conductive insert and impacting the phosphor layer when an electric field is created between the cold cathode and the phosphor layer due to applied voltages at the cold cathode, conductive insert and phosphor layer, the phosphor layer emitting light through the face portion in response to electrons incident thereon.

2. The light emitting device of claim 1, the tubulator generating secondary electron emission due to electrons incident thereon.

3. The light emitting device of claim 1, further comprising a mirror layer disposed on the phosphor layer wherein the electrons pass through the mirror layer to impact the phosphor layer and wherein the mirror layer reflects the light emitted by the phosphor layer towards the face portion to increase intensity of light output by the light emitting device.

4. The light emitting device of claim 1, further comprising a device controller for generating the applied voltages, wherein the device controller varies the voltage of one or more of the applied voltages to vary the brightness of light emitted from the light emitting device.

5. The light emitting device of claim 1, further comprising a second conductive insert wherein the electrical potential of the second conductive insert further controls the extraction and defocusing of electrons.

6. Light emitting device, comprising:
an enclosure with a face portion;
a cold cathode within the enclosure;
a phosphor layer disposed on an interior surface of the face portion;
a conductive ring between the cold cathode and the phosphor layer;
a first electrical conductor extending through the enclosure to provide electrical connectivity to the cold cathode;
a second electrical conductor extending through the enclosure to provide electrical connectivity to the conductive ring; and
a third electrical conductor extending through the enclosure to provide electrical connectivity to the phosphor layer;
electrons from the cold cathode impacting the phosphor layer when an electric field is created between the cold cathode and the phosphor layer due to applied voltages at the cold cathode, conductive ring and phosphor layer, the phosphor layer emitting light through the face portion in response to electrons incident thereon.

7. The light emitting device of claim 6, wherein the applied voltage to the phosphor layer is approximately 10 kilovolts, the applied voltage to the cold cathode is approximately minus two hundred volts, and the voltage applied to the conductive ring is approximately ground.

8. The light emitting device of claim 6, further comprising a mirror layer disposed on the phosphor layer wherein the electrons pass through the mirror layer to impact the phosphor layer and wherein the mirror layer reflects the light emitted by the phosphor layer towards the face portion to increase intensity of light output by the light emitting device.

9. The light emitting device of claim 6, wherein varying potential difference between the cold cathode, the conductive ring and the phosphor layer varies light output of the light emitting device.

10. The light emitting device of claim 6, further comprising a device controller for generating the applied voltages, wherein the device controller varies the voltage of one or more of the applied voltages to vary the brightness of light emitted from the light emitting device.

11. Light emitting device, comprising:
an enclosure with a face portion;
a transparent conductive coating on the interior surface of the face portion;
a phosphor layer disposed on an interior surface of the enclosure opposite to the face portion;
a cold cathode within the enclosure;
a conductive ring between the cold cathode and the face portion;
a first electrical conductor extending through the enclosure to provide electrical connectivity to the cold cathode;
a second electrical conductor extending through the enclosure to provide electrical connectivity to the conductive ring;
a third electrical conductor extending through the enclosure to provide electrical connectivity to the transparent conductive coating; and
a fourth electrical conductor extending through the enclosure to provide electrical connectivity to the phosphor layer;
electrons from the cold cathode being defocused by the conductive ring and impacting the phosphor layer when an electric field is created between the cold cathode and the phosphor layer due to applied voltages at the cold cathode, conductive insert, transparent conductive coating and phosphor layer, the phosphor layer emitting light through the transparent conductive coating and face portion in response to electrons incident thereon.

12. The light emitting device of claim 11, the voltage applied to the transparent conductive coating repelling the electrons.

13. The light emitting device of claim 11, wherein the applied voltage to the phosphor layer is approximately 10 kilovolts, the applied voltage to the cold cathode is approximately minus two hundred volts, and the voltage applied to the conductive ring is approximately ground.

14. The light emitting device of claim 11, further comprising a mirror layer disposed between the phosphor layer and the interior surface opposite the face portion, wherein the mirror layer reflects the light emitted by the phosphor layer towards the face portion to increase intensity of light output by the light emitting device.

15. The light emitting device of claim 11, wherein varying potential difference between the cold cathode, the conductive ring and the phosphor layer varies light output of the light emitting device.

16. The light emitting device of claim 11, further comprising a device controller for generating the applied voltages.

17. The light emitting device of claim 16, wherein the device controller varies the voltage of one or more of the applied voltages to vary the brightness of light emitted from the light emitting device.

18. The light emitting device of claim 11, wherein the phosphor layer comprises three separate areas of electrically isolated red, green and blue phosphor that emit red, green and blue light, respectively, when impacted by electrons.

19. The light emitting apparatus of claim 18, each area of phosphor further comprising a mirror layer deposited thereon to reflect light emitted by the area of phosphor through the face portion.

20. The light emitting device of claim 11, wherein the cold cathode is formed by chemical vapor deposition.
